(19) United States
(12) Patent Application Publication
(10) Pub. No.: US 2026/0289686 A1
(43) Pub. Date: Sep. 24, 2026

(54) COMPREHENSIVE INSURANCE SYSTEM AND METHOD FOR COMPENSATING VEHICLE VALUE DEPRECIATION DUE TO DAMAGE REPORT EVENTS

(71) Applicant: Michael Ward, Spicewood, TX (US)

(72) Inventor: Michael Ward, Spicewood, TX (US)

(21) Appl. No.: 19/221,121

(22) Filed: May 28, 2025

Related U.S. Application Data
(60) Provisional application No. 63/776,841, filed on Mar. 24, 2025.

(51) Int. Cl. G06Q 40/08; G06Q 30/0201

(52) U.S. Cl. CPC G06Q 40/084; G06Q 30/0206; G06Q 40/08221; G06Q 40/09

(57) ABSTRACT

A method for protecting vehicle resale value against damage-report-based depreciation may include providing a specialized insurance policy covering non-total-loss events recorded on vehicle history reports. The method may include receiving and verifying a claim based on a damage entry in a third-party history report. The method may include confirming repair completion. The method may include determining a pre- and post-incident vehicle value using a machine learning-enabled depreciation engine. The method may include paying the vehicle owner for the computed value loss. The depreciation engine may apply an adaptive algorithm that may adjust to context by accounting for vehicle-specific and event-specific factors. The calculated post-event value reduction may be tailored based on the vehicle's type or class, region or market of sale, the severity of damage sustained, and prevailing market trends for vehicles with incident histories.

### FIELD OF THE INVENTION

The present disclosure relates generally to vehicle insurance and valuation systems. More particularly, the disclosure relates to systems and methods for compensating vehicle owners for market value depreciation resulting from damage events recorded on third-party vehicle history reports.

### BACKGROUND

The disclosed embodiments are described in detail below with reference to the accompanying drawings. This description is illustrative rather than restrictive. The disclosed embodiments can be modified in arrangement and detail without departing from the principles set forth herein.

Vehicle history reports have become a standard reference tool in the automotive industry. Services such as CARFAX® and AutoCheck® compile and provide detailed information about a vehicle's past, including accidents, damage events, maintenance records, and ownership history. These reports significantly influence used vehicle purchase decisions and, consequently, vehicle resale values.

When a vehicle sustains damage from events such as hailstorms, floods, or falling objects, and this damage is subsequently recorded in a third-party vehicle history report, the vehicle often experiences substantial depreciation in market value. This depreciation occurs even when the vehicle has been professionally repaired to pre-damage condition. Industry data indicates that vehicles with damage history can lose between 10% and 30% of their market value solely due to the presence of these records in vehicle history reports.

Conventional automobile insurance policies typically cover physical repairs to damaged vehicles but do not address the subsequent loss in market value caused by the documentation of these events in vehicle history reports. This gap in coverage represents a significant financial exposure for vehicle owners, who may find their vehicle's equity substantially reduced following a documented damage event, even after complete physical restoration.

While some jurisdictions permit third-party diminished value claims against at-fault parties in collision scenarios, most insurance policies explicitly exclude first-party diminished value coverage. Furthermore, for “no-fault” incidents such as hail damage, flood damage, or damage from falling objects, vehicle owners generally have no recourse to recover the lost market value attributable to the history report entry.

There exists a need for an insurance system that specifically addresses this gap in coverage by providing compensation for the loss in vehicle market value caused by the documentation of damage events in third-party vehicle history reports. Such a system would protect vehicle owners' equity beyond the physical repair coverage offered by traditional insurance policies.

### SUMMARY

The present disclosure may be implemented in various ways, and the specific embodiments described herein are presented for illustrative purposes and should not be interpreted as limiting. Various modifications, substitutions, and alterations can be made without departing from the scope of the present disclosure.

The present disclosure provides systems and methods for protecting vehicle owners against market value depreciation caused by damage events recorded in third-party vehicle history reports. The systems and methods described herein offer a specialized insurance or service contract coverage that compensates vehicle owners for the difference between a vehicle's pre-incident market value and its reduced post-incident market value, where the reduction is attributable to the documentation of a damage event in a vehicle history report.

In one aspect, a method is provided for protecting vehicle resale value against damage-report-based depreciation. The method includes offering a specialized insurance policy covering non-total-loss events recorded on vehicle history reports; receiving and verifying a claim based on a damage entry in a third-party history report; confirming repair completion; determining pre- and post-incident vehicle values using a machine learning-enabled depreciation engine; and paying the vehicle owner for the computed value loss.

In another aspect, a computerized system is provided comprising a customer interface, a backend insurer platform with data integration, valuation, and fraud modules, API-based connections to external history and valuation services, fraud scoring components, and a payment processing engine. The system may optionally include a blockchain-based audit trail for enhanced security and transparency.

In yet another aspect, a computer-readable medium is provided storing program instructions that, when executed, cause a computing system to implement the methods described herein.

The systems and methods disclosed herein address a significant gap in the vehicle insurance market by providing a dedicated solution for compensating owners for market value depreciation caused by damage history. By leveraging technology such as machine learning valuation models, API integration with vehicle history databases, and optional blockchain audit trails, the disclosed embodiments provide an efficient, accurate, and secure means of protecting vehicle owners' financial interests.

### BRIEF DESCRIPTION OF THE DRAWINGS

The accompanying drawings, which are incorporated in and constitute a part of this specification, illustrate embodiments of the disclosure and, together with the description, serve to explain the principles of the disclosure.

FIG. 1 illustrates a system architecture diagram for a Car Appraisal Insurance (CAP) insurance system according to an embodiment of the present disclosure.

FIG. 2 illustrates a claims processing flowchart according to an embodiment of the present disclosure.

FIG. 3 illustrates a depreciation valuation engine data flow according to an embodiment of the present disclosure.

FIG. 4 illustrates a fraud prevention subsystem according to an embodiment of the present disclosure.

FIG. 5 illustrates a digital claims submission interface according to an embodiment of the present disclosure.

FIG. 6 illustrates a blockchain-based audit trail according to an embodiment of the present disclosure.

FIG. 7 illustrates an integration and API modular system according to an embodiment of the present disclosure.

FIG. 8 illustrates an insurance coverage condition flowchart according to an embodiment of the present disclosure.

FIG. 9 is a block diagram of an exemplary computing device that may be used to implement various aspects of the invention.

### DETAILED DESCRIPTION

Reference will now be made in detail to embodiments of the present disclosure, examples of which are illustrated in the accompanying drawings. The following description is provided to enable those skilled in the art to make and use the disclosed embodiments, and is not intended to limit the scope of what the inventors regard as their invention.

### System Architecture Overview

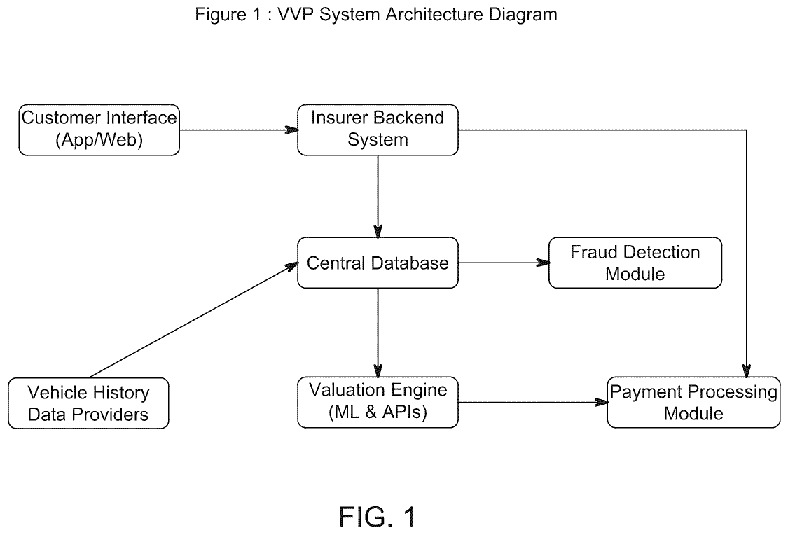

FIG. 1 illustrates a system architecture diagram for a Car Appraisal Insurance (CAP) insurance system according to an embodiment of the present disclosure. The system includes a central database connected to multiple functional modules including a master diagramed system, a fraud detection module, a payments processing module, a valuation engine, vehicle history data providers, and customer interface applications.

The system architecture is designed to provide an end-to-end solution for processing Car Appraisal Insurance (CAP) claims. The central database serves as the primary repository for policy information, vehicle data, claim records, and valuation results. The various modules communicate with the central database to retrieve and store information as needed throughout the claims process.

The master diagramed system coordinates the overall operation of the Car Appraisal Insurance (CAP) system, orchestrating the workflow between different modules and ensuring proper sequencing of processes. The fraud detection module analyzes incoming claims for potential fraudulent activity using various verification techniques and risk scoring algorithms. The payments processing module handles the disbursement of claim payments to policyholders once claims have been approved.

The valuation engine, which may incorporate data from sources such as Kelley Blue Book® (KBB) and Manheim Market Report (MMR), calculates the depreciation in vehicle value attributable to damage events recorded in vehicle history reports. Vehicle history data providers, such as CARFAX® and AutoCheck®, supply the system with official vehicle history information used to verify claim eligibility. Customer interface applications provide policyholders with a means to interact with the system, submit claims, and track claim status.

In some embodiments, the system architecture may be implemented as a cloud-based platform, allowing for scalability, reliability, and accessibility. The modular design enables components to be updated or replaced independently, facilitating system maintenance and enhancement without disrupting overall functionality.

### Claims Processing Workflow

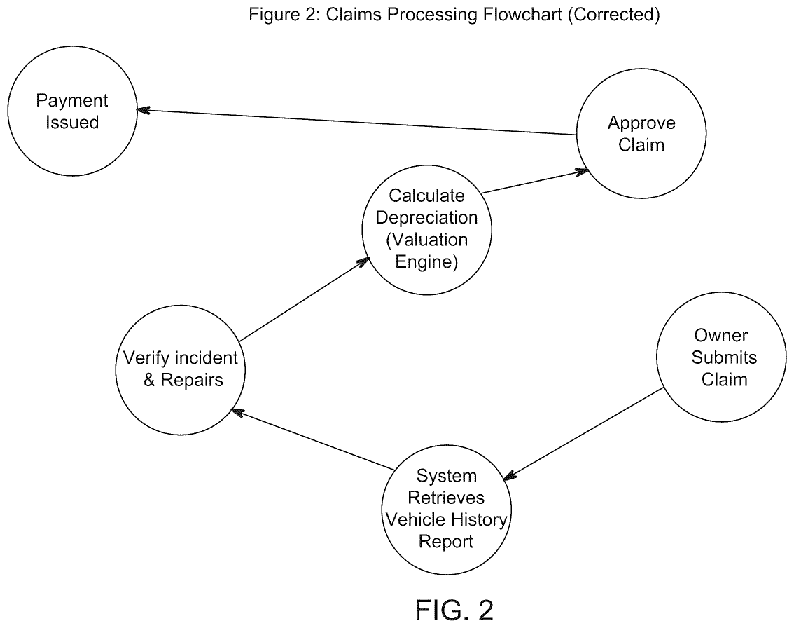

FIG. 2 illustrates a claims processing flowchart according to an embodiment of the present disclosure. The flowchart depicts the sequence of steps involved in processing a Car Appraisal Insurance (CAP) claim, from initial submission to payment issuance.

The claims process begins when an owner submits a claim through the system's customer interface. Upon submission, the system retrieves the vehicle's history report from a third-party provider to verify the presence and details of the reported incident. The system then proceeds to verify both the incident and the completion of repairs, ensuring that the vehicle has been restored to operational condition following the damage event.

Once verification is complete, the system may remove any lien information to prepare for accurate valuation. The depreciation calculation is then performed by the valuation engine, which determines the difference between the vehicle's pre-incident value and its post-incident value with the damage history. Finally, if the claim is approved, payment is issued to the policyholder for the calculated depreciation amount, subject to policy terms and conditions.

This structured workflow ensures consistent processing of claims while maintaining appropriate verification steps to validate claim legitimacy. The automated nature of the process allows for efficient handling of claims with minimal manual intervention, reducing processing time and administrative costs.

### Depreciation Valuation Engine

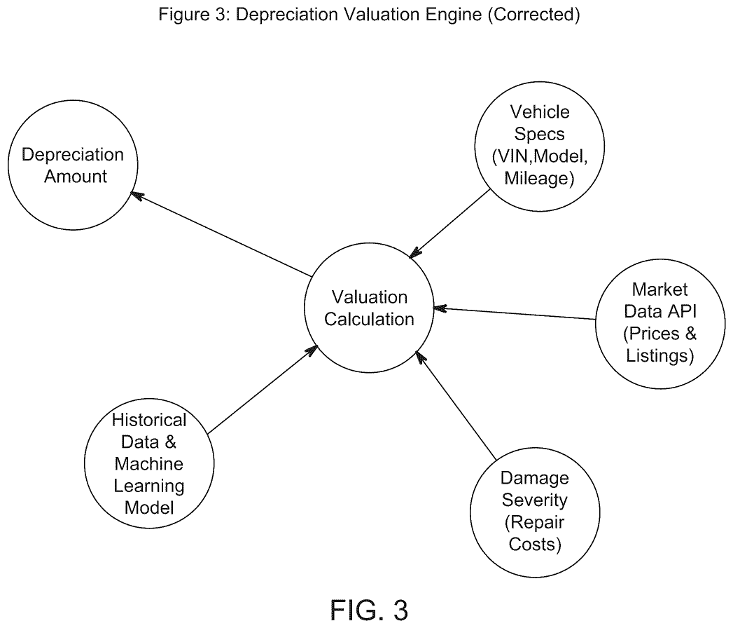

FIG. 3 illustrates a depreciation valuation engine according to an embodiment of the present disclosure. The valuation engine is a central component of the Car Appraisal Insurance (CAP) system, responsible for calculating the monetary impact of a damage event on a vehicle's market value.

The valuation calculation process incorporates multiple inputs to determine an accurate depreciation amount. These inputs include vehicle specifications (such as VIN, model, and mileage), market data from API sources providing current prices and listings for comparable vehicles, damage severity information derived from repair costs, and historical data processed through machine learning models.

The valuation engine processes these inputs to calculate the difference between a vehicle's pre-incident market value and its post-incident market value with the damage history. This calculation represents the depreciation amount that may be eligible for compensation under the Car Appraisal Insurance (CAP) policy.

In some embodiments, the valuation engine may employ machine learning algorithms trained on extensive datasets of vehicle sales and appraisals to improve accuracy over time. These algorithms can identify patterns in how specific types of damage events affect the market value of different vehicle makes, models, and age groups, allowing for more precise depreciation calculations.

The valuation engine may also adjust calculations based on regional market variations, as the impact of damage history on vehicle value can differ by geographic location. This adaptability ensures that compensation amounts reflect actual market conditions in the policyholder's region.

### Fraud Prevention Subsystem

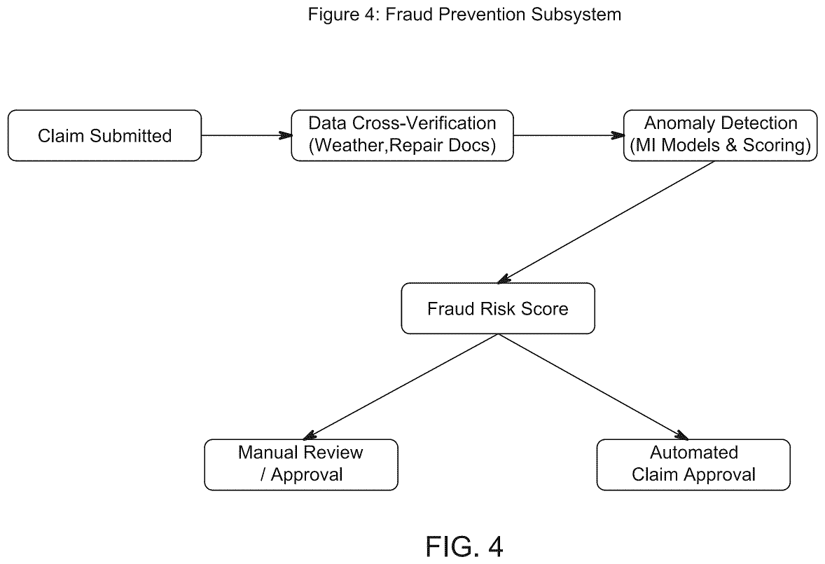

FIG. 4 illustrates a fraud prevention subsystem according to an embodiment of the present disclosure. The fraud prevention subsystem is designed to identify potentially fraudulent claims and protect the integrity of the Car Appraisal Insurance (CAP) program.

When a claim is submitted, the system initiates two parallel processes: data cross-verification and anomaly detection. The data cross-verification process checks the submitted claim against databases, blacklists, and documentation to confirm consistency and authenticity. Simultaneously, anomaly detection employs artificial intelligence, modeling, and scoring techniques to identify unusual patterns or discrepancies that may indicate fraudulent activity.

The results of these processes are combined to generate a fraud risk score for the claim. Based on this score, the claim may be routed for automated approval if the risk is low, or for manual review and approval if the risk score exceeds predetermined thresholds.

The fraud prevention subsystem may incorporate various verification techniques, including:
Weather data verification to confirm that claimed events (such as hail or flood damage) actually occurred at the reported location and time
Repair facility verification to confirm the authenticity of repair documentation
Temporal analysis to identify suspicious timing patterns in policy purchase, incident occurrence, and claim submission
Document analysis to detect potentially altered or falsified records

By implementing robust fraud prevention measures, the system maintains the financial viability of the Car Appraisal Insurance (CAP) program while ensuring legitimate claims are processed efficiently.

### Digital Claims Submission Interface

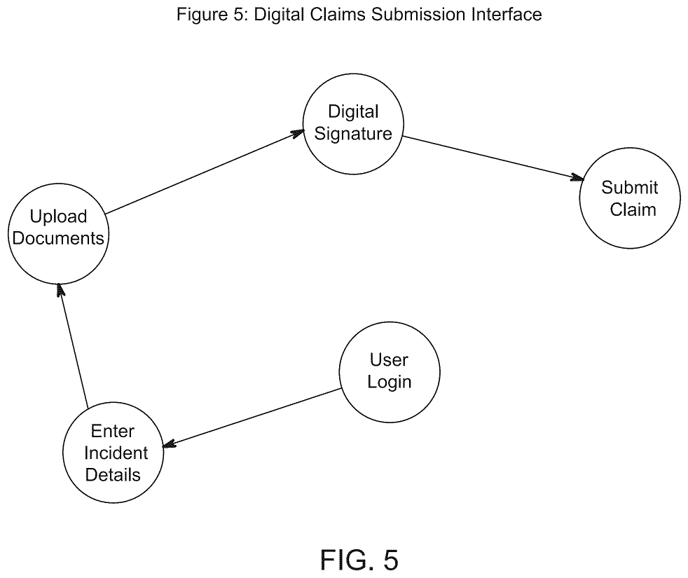

FIG. 5 illustrates a digital claims submission interface according to an embodiment of the present disclosure. The digital interface provides policyholders with a streamlined method for submitting Car Appraisal Insurance (CAP) claims.

The claims submission process begins with user login to the system, which authenticates the policyholder and retrieves their policy information. The policyholder then enters incident details, including the date, location, and nature of the damage event. The system provides fields for uploading supporting documentation, such as vehicle history reports, repair invoices, and photographs.

Before final submission, the policyholder provides a digital signature attesting to the accuracy of the information provided. Once all required information and documentation have been provided, the policyholder submits the claim for processing.

The digital claims submission interface may be implemented as a web portal, mobile application, or both, providing convenient access for policyholders. The interface may include features such as document scanning capabilities, guided form completion, and real-time claim status tracking to enhance the user experience.

By facilitating digital claim submission, the system reduces paperwork, accelerates the claims process, and provides a convenient experience for policyholders while ensuring all necessary information is collected for claim processing.

### Blockchain-Based Audit Trail

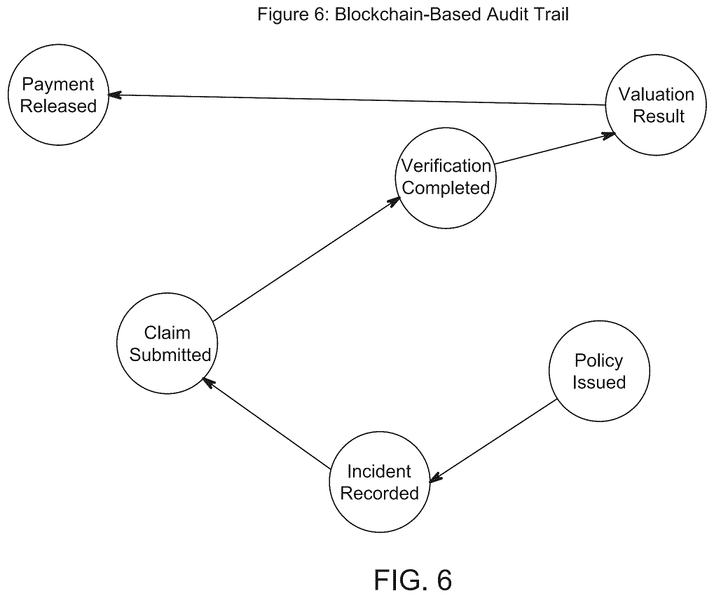

FIG. 6 illustrates a blockchain-based audit trail according to an embodiment of the present disclosure. The blockchain audit trail provides an immutable record of key events in the policy lifecycle and claims process.

The blockchain records a chronological sequence of events beginning with policy issuance and potentially including incident recording, claim submission, verification completion, valuation results, and payment release. Each event is recorded as a transaction on the blockchain, creating a tamper-proof audit trail that can be referenced for verification purposes.

The blockchain-based audit trail offers several advantages:
Enhanced security through cryptographic verification of transactions
Immutable record-keeping that prevents unauthorized alterations
Transparent history accessible to authorized parties
Reduced disputes through objective documentation of events

In some embodiments, the blockchain implementation may utilize smart contracts to automate certain aspects of the claims process. For example, a smart contract might automatically trigger payment when all required verification steps have been successfully completed and recorded on the blockchain.

While the blockchain-based audit trail is presented as an optional component of the system, its inclusion can significantly enhance the security, transparency, and auditability of the Car Appraisal Insurance (CAP) program.

### Integration and API Modular System

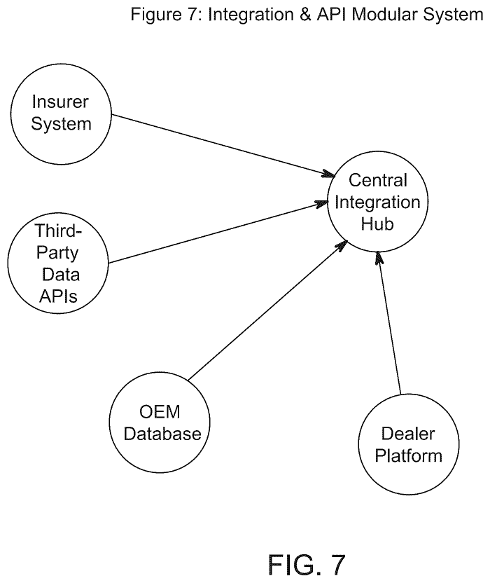

FIG. 7 illustrates an integration and API modular system according to an embodiment of the present disclosure. The integration system facilitates communication between the Car Appraisal Insurance (CAP) platform and external systems through a central integration hub.

The central integration hub connects to various external entities including insurer systems, third-party data APIs, OEM databases, and dealer platforms. This hub-and-spoke architecture enables the Car Appraisal Insurance (CAP) system to exchange information with multiple partners and data sources while maintaining a consistent interface for each integration.

The modular design of the integration system allows for flexible configuration and scaling. New integration partners can be added without disrupting existing connections, and individual integrations can be updated or replaced as needed. This adaptability is particularly valuable as the Car Appraisal Insurance (CAP) program expands to new markets or incorporates additional data sources.

The API-based approach enables real-time data exchange, allowing the system to retrieve current vehicle values, history reports, and other information as needed during the claims process. This real-time capability ensures that valuations and claim decisions are based on the most up-to-date information available.

In some embodiments, the integration system may implement security measures such as API authentication, encryption, and rate limiting to protect sensitive data and prevent abuse of the integration endpoints.

### Insurance Coverage Conditions

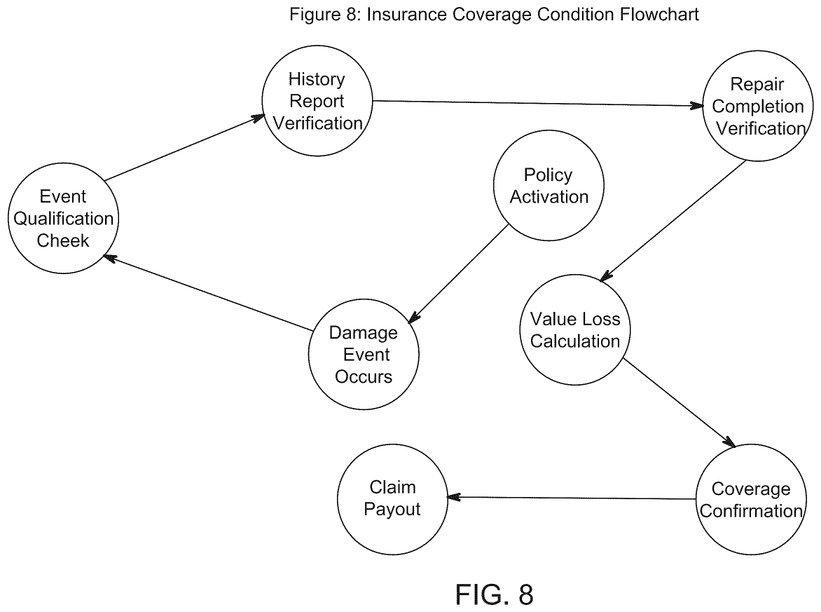

FIG. 8 illustrates an insurance coverage condition flowchart according to an embodiment of the present disclosure. The flowchart depicts the sequence of conditions that must be satisfied for a claim to qualify for coverage under a Car Appraisal Insurance (CAP) policy.

The process begins when a damage event occurs to an insured vehicle. The system first performs a coverage confirmation to verify that the policy was active at the time of the event and that the event falls within the scope of covered perils. The system then conducts a policy activation check to confirm that the policy was in force prior to the event and not in a waiting period or grace period.

An event qualification check determines whether the specific type of damage event is covered under the policy terms. Typical covered events may include hail damage, flood damage, damage from falling objects, and other non-collision incidents that result in repairable damage.

The history report verification confirms that the damage event has been documented in a recognized third-party vehicle history report, establishing the basis for the claimed depreciation. The repair completion certificate verification ensures that the vehicle has been professionally repaired following the damage event, as the coverage is intended to address market value depreciation rather than physical damage.

Once these conditions have been satisfied, the system proceeds with value loss calculation to determine the compensation amount. If all conditions are met and the value loss calculation produces a positive result, the claim proceeds to payment.

These coverage conditions establish clear criteria for claim eligibility, ensuring consistent application of policy terms while providing transparent guidelines for policyholders regarding covered scenarios.

### Computing Device

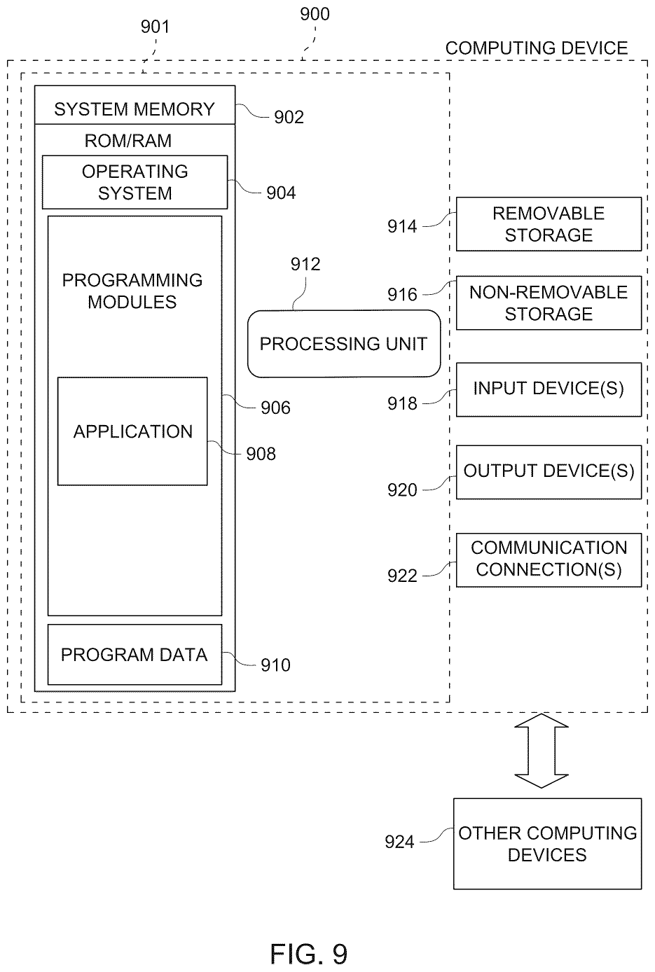

FIG. 9 is a block diagram illustrating an exemplary computing device 900 that may be used to implement various aspects of the invention. The device 900 includes a processing unit 912, a system memory 901, and a system bus 913 that couples various system components including the system memory to the processing unit 912.

The system memory 901 includes read-only memory (ROM) 902 and random access memory (RAM) 902. A basic input/output system 903 (BIOS), containing the basic routines that help to transfer information between elements within the computer 900, such as during start-up, is typically stored in ROM 902.

The computer 900 may include a hard disk drive 914 for reading from and writing to a hard disk, a magnetic disk drive 916 for reading from or writing to a removable magnetic disk 917, and an optical disk drive 918 for reading from or writing to a removable optical disk 919 such as a CD-ROM or other optical media. The hard disk drive 914, magnetic disk drive 916, and optical disk drive 918 are connected to the system bus 913 by a hard disk drive interface 920, a magnetic disk drive interface 922, and an optical drive interface 924, respectively.

A number of program modules may be stored on the hard disk, magnetic disk 917, optical disk 919, ROM 902 or RAM 902, including an operating system 904, one or more application programs 906, other program modules 908, and program data 910. A user may enter commands and information into the computer 900 through input devices such as a keyboard 926 and pointing device 927, such as a mouse.

The computer 900 may operate in a networked environment using logical connections to one or more remote computers, such as a remote computer 929. The remote computer 929 may be another personal computer, a server, a router, a network PC, a peer device or other common network node, and typically includes many or all of the elements described above relative to the computer 900.

Other programming modules that may be used in accordance with embodiments of the present disclosure may include electronic mail and contacts applications, word processing applications, spreadsheet applications, database applications, slide presentation applications, drawing or computer-aided application programs, etc . . . . Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

### Method for Protecting Vehicle Resale Value

In accordance with embodiments of the present disclosure, a method is provided for protecting vehicle resale value against damage-report-based depreciation. The method includes several key steps that together form a comprehensive approach to addressing market value depreciation caused by damage events recorded in vehicle history reports.

The method begins with providing a specialized insurance policy or service contract that specifically covers loss in market value due to non-total-loss damage events that become recorded on third-party vehicle history reports. This coverage is distinct from traditional physical damage coverage, as it addresses the financial impact of the damage history rather than the cost of repairs.

When a qualifying damage event occurs, the method includes detecting or receiving notification of the event. This notification may come directly from the policyholder through a digital claims interface, or in some embodiments, may be automatically detected through integration with vehicle history report providers or connected vehicle systems.

The method proceeds with verifying claim conditions, including confirming that the damage event is documented on a vehicle history report obtained from a recognized third-party service, and that the vehicle has been repaired following the event as evidenced by certified repair documentation. Additional verification steps may include confirming policy coverage, validating the timing of events, and checking for potential fraud indicators.

Once verification is complete, the method includes determining the amount of value depreciation attributable to the recorded event. This determination is made using a computerized depreciation valuation engine that computes the difference between the vehicle's pre-event market value and its post-event market value. The computation incorporates data from external vehicle valuation sources and may apply algorithms or machine learning models to ensure accuracy.

Finally, the method includes issuing payment or credit to the policyholder corresponding to the determined depreciation amount, in accordance with the coverage policy terms. This payment compensates the vehicle owner for the loss in resale value caused by the damage event's appearance in the vehicle's history.

In some embodiments, the method may include additional steps such as:
Integrating live market data via APIs to ensure current pricing information is used in valuation calculations
Authenticating vehicle history reports and repair documentation via third-party data streams
Cross-checking incident details with external data sources such as weather databases
Processing claims through a digital submission platform that provides a user-friendly interface
Scoring claims for fraud risk using detection models that analyze claim data
Recording claim events on a blockchain ledger to create an immutable audit trail

By implementing this method, vehicle owners can be protected against the financial impact of damage-related depreciation that would otherwise represent an uninsured risk.

### Computerized System for Vehicle Value Depreciation Protection

Embodiments of the present disclosure include a computer-implemented system for vehicle value depreciation protection. The system comprises several integrated components that work together to provide comprehensive protection against market value depreciation caused by damage events recorded in vehicle history reports.

The system includes a customer-facing submission interface, which may be implemented as a web portal or mobile application. This interface is configured to collect claim information from insured vehicle owners, including incident details and electronic documentation. The interface provides a user-friendly means for policyholders to initiate claims, upload supporting documents, and track claim status.

An insurer-facing backend platform comprises a database and business logic components that receive data from the submission interface and manage policy information and claim processing. This platform serves as the operational core of the system, coordinating the various processes involved in policy administration and claim handling.

A third-party data integration module is configured to interface with external vehicle history report services to automatically retrieve official incident records for the vehicle. This module also interfaces with external valuation data sources and verification services, enabling the system to access the information needed for claim verification and valuation.

A valuation engine module, operable on one or more processors, is programmed to calculate the lost market value of the vehicle due to a verified damage event. The engine processes inputs including pre-event valuation data and post-event adjustment factors or models, producing an output representing a monetary depreciation amount.

A payment processing module is configured to initiate payment of the depreciation amount to the insured upon claim approval. This module may support various payment methods, including electronic funds transfer, check issuance, or credit to a designated account.

The modules are operatively connected such that a claim initiated through the customer-facing interface is automatically verified using the third-party data integration module, evaluated by the valuation engine module, and, if approved, settled via the payment processing module.

In some embodiments, the system may include additional components such as:
A fraud detection subsystem with algorithms for anomaly detection and consistency checks
A machine learning-based predictive model trained to estimate vehicle value loss due to damage history stigma
A plurality of API connectors to different external services for data integration
A blockchain-based audit trail module that records transactions on a distributed ledger
A region-specific rules engine that applies appropriate parameters based on geographic location

The system's modular architecture allows for flexible deployment and scaling, enabling adaptation to different markets, integration with various partners, and enhancement with new features over time.

Integration with External Systems

Embodiments of the present disclosure include various approaches for integrating the Car Appraisal Insurance (CAP) system with external systems and stakeholders. These integrations enhance the functionality and reach of the system while providing seamless experiences for users and partners.

Integration with vehicle history report providers is a fundamental aspect of the system. Through API connections or secure data exchange protocols, the system can retrieve official vehicle history information from providers such as CARFAX®, AutoCheck®, or similar regional services. This integration enables automatic verification of damage event records, a critical step in the claims process.

The system may also integrate with insurance company systems, including policy administration platforms, claims management systems, and payment processing infrastructure. These integrations allow the Car Appraisal Insurance (CAP) coverage to be offered alongside traditional auto insurance policies, with coordinated administration and claim handling.

Dealership and automotive manufacturer (OEM) integrations enable the Car Appraisal Insurance (CAP) coverage to be offered at the point of vehicle sale. The system can connect to dealer management systems and F&I (Finance & Insurance) platforms, allowing dealerships to enroll customers in the program during the vehicle purchase process. Integration with OEM systems may provide additional data sources for vehicle specifications and certified repair information.

Financial institution integrations allow the system to coordinate with vehicle lenders and lessors. These integrations may facilitate premium payments, claim disbursements, and information sharing regarding vehicles serving as collateral for loans.

In some embodiments, the system may integrate with telematics platforms or connected vehicle systems. These integrations could provide additional data regarding vehicle usage, location, and condition, potentially enhancing underwriting accuracy and claim verification capabilities.

The system's API-based architecture supports these integrations through standardized interfaces, data formats, and security protocols. The modular design allows specific integrations to be developed, deployed, and updated independently, facilitating partnerships with a diverse range of external entities.

### Fraud Prevention and Risk Management

Embodiments of the present disclosure include comprehensive fraud prevention and risk management capabilities designed to protect the integrity of the Car Appraisal Insurance (CAP) program while ensuring legitimate claims are processed efficiently.

The fraud prevention subsystem employs multiple techniques to identify potentially fraudulent claims. Anomaly detection algorithms analyze claim patterns and characteristics, flagging unusual or suspicious elements for further review. Data cross-verification processes compare claim information against various sources to identify inconsistencies or contradictions.

The system may assign a fraud risk score to each claim by evaluating factors such as:
Claim timing relative to policy inception
Frequency of claims from the same policyholder
Consistency between reported damage and repair documentation
Verification of weather events for claims involving hail, flood, or similar perils
Authentication of repair facility credentials and documentation
Correlation between damage severity and repair costs

Based on the fraud risk score, claims may be automatically approved, routed for manual review, or flagged for investigation. This risk-based approach allows the majority of legitimate claims to be processed quickly while focusing scrutiny on claims with higher risk indicators.

The system may employ machine learning models that continuously improve fraud detection capabilities by learning from historical claims data. These models can identify subtle patterns and relationships that might not be apparent through rule-based detection alone.

In some embodiments, the fraud prevention capabilities may be enhanced through blockchain technology, which provides an immutable record of claim events and supporting documentation. The transparent and tamper-resistant nature of blockchain records can deter fraudulent activity while providing a reliable audit trail for investigations if needed.

By implementing robust fraud prevention and risk management measures, the system maintains the financial sustainability of the Car Appraisal Insurance (CAP) program while providing efficient service to honest policyholders.

### Optional Blockchain Implementation

Embodiments of the present disclosure may optionally include blockchain technology to enhance security, transparency, and trust in the Car Appraisal Insurance (CAP) system. While not required for core functionality, blockchain implementation offers several advantages for certain deployments of the system.

The blockchain-based audit trail creates an immutable record of key events in the policy lifecycle and claims process. Each significant action-such as policy issuance, incident recording, claim submission, verification completion, valuation results, and payment release—can be recorded as a transaction on a distributed ledger. This creates a tamper-proof history that can be referenced to resolve disputes or verify compliance.

In some embodiments, smart contracts may be employed to automate certain aspects of the claims process. Smart contracts are self-executing contracts with the terms directly written into code. For example, a smart contract might automatically trigger payment when predefined conditions are met and verified on the blockchain, such as confirmation of a damage event record and verification of repair completion.

The blockchain implementation may be structured as a private or consortium blockchain, with participation limited to authorized parties such as the insurance provider, vehicle history report services, and potentially regulators or auditors. This controlled access model balances transparency with privacy considerations.

Data privacy can be maintained within the blockchain implementation by storing sensitive information off-chain while recording cryptographic proofs on-chain. For example, the system might store a hash of a vehicle history report on the blockchain rather than the full report, allowing verification of the report's authenticity without exposing all details publicly.

The optional nature of the blockchain implementation allows the system to be deployed in various regulatory environments and technical contexts. In regions with stringent data protection regulations or in deployments where simplicity is prioritized, the system can operate without the blockchain component while maintaining its core functionality.

### Valuation Methodology

Embodiments of the present disclosure include sophisticated valuation methodologies for determining the depreciation in vehicle market value attributable to damage events recorded in vehicle history reports. These methodologies ensure accurate and fair compensation for policyholders experiencing value loss due to damage history.

The valuation process begins with establishing the vehicle's pre-incident value—the market value the vehicle would command if it had no damage history. This baseline value may be determined using current market data for comparable vehicles (same make, model, year, trim, and similar mileage) with clean history reports. The system may retrieve this data from multiple sources including industry-standard valuation guides, auction results, and retail listing platforms.

Next, the system determines the vehicle's post-incident value—the market value with the damage event recorded in its history. This determination may involve several approaches:
Analysis of comparable vehicles with similar damage history
Application of depreciation factors derived from market research
Utilization of industry-accepted formulas for diminished value calculation
Implementation of machine learning models trained on historical sales data

The depreciation amount is calculated as the difference between the pre-incident value and the post-incident value. This calculation represents the financial impact of the damage history on the vehicle's market value, independent of any physical damage (which is presumed to have been repaired).

The valuation methodology may incorporate various factors that influence the impact of damage history on vehicle value:
Vehicle age and mileage (newer vehicles typically experience greater percentage depreciation from damage history)
Vehicle make and model (premium brands may experience different depreciation patterns)
Type and severity of damage (as indicated by repair costs or damage descriptions)
Regional market variations (impact of damage history may vary by geographic location)
Current market conditions (overall market strength or weakness)

In some embodiments, the valuation methodology may employ machine learning algorithms that continuously improve accuracy by analyzing outcomes of actual vehicle sales. These algorithms can identify complex relationships between vehicle characteristics, damage types, and market value impacts that might not be captured by simpler approaches.

The system's valuation methodology is designed to be transparent, with results that can be explained and supported by market data. This transparency helps build trust with policyholders and supports the defensibility of valuation determinations if questioned or reviewed.

### Implementation in Various Contexts

Embodiments of the present disclosure can be implemented in various contexts and distribution channels, providing flexibility in how the Car Appraisal Insurance (CAP) solution reaches the market and serves different stakeholder needs.

The system may be implemented as a traditional insurance product offered by property and casualty insurers. In this context, the Car Appraisal Insurance (CAP) coverage might be offered as an endorsement to standard auto insurance policies or as a standalone coverage option. Insurers can leverage their existing customer relationships, distribution networks, and claims infrastructure to bring the product to market efficiently.

Alternatively, the system may be implemented as a dealer-offered product at the point of vehicle sale. Automotive dealerships can present the Car Appraisal Insurance (CAP) coverage as an F&I (Finance & Insurance) product alongside extended warranties, gap insurance, and other protection plans. This implementation leverages the dealership's direct interaction with customers during the vehicle purchase process, when protection of the new asset may be particularly appealing.

The system may also be implemented through automotive manufacturers (OEMs) as part of certified pre-owned programs or new vehicle protection packages. Manufacturers can offer the coverage to enhance the value proposition of their vehicles and strengthen brand loyalty through comprehensive protection offerings.

Financial institutions such as banks and credit unions that provide auto loans may implement the system as a collateral protection product. By offering Car Appraisal Insurance (CAP) to borrowers, these institutions can reduce the risk of negative equity situations where damage history might otherwise leave a borrower owing more than the vehicle's diminished value.

In some embodiments, the system may be implemented as a direct-to-consumer offering through digital channels. This implementation bypasses traditional intermediaries, allowing vehicle owners to purchase coverage directly through web or mobile interfaces.

The modular architecture of the system supports these varied implementations through flexible integration capabilities and configurable business rules. The core functionality-protecting vehicle owners against market value depreciation caused by damage history-remains consistent across implementations, while the distribution, branding, and specific terms may be adapted to each context.

### Computer-Implemented Aspects

Embodiments of the present disclosure include computer-implemented aspects that enable the efficient operation of the Car Appraisal Insurance (CAP) system. These technological elements are integral to the system's functionality and performance.

The system may be implemented using a distributed computing architecture, with components deployed across multiple servers or cloud-based resources. This architecture provides scalability to handle varying transaction volumes and resilience against individual component failures.

Data storage may utilize relational databases for structured information such as policy details and claim records, potentially complemented by NoSQL databases for handling unstructured data such as documents and images. Database design incorporates appropriate indexing and partitioning strategies to maintain performance as data volumes grow.

The system's API layer facilitates communication between internal components and external systems. RESTful API designs with standardized authentication, request/response formats, and error handling provide a consistent integration approach. API gateways may manage traffic, enforce security policies, and provide monitoring capabilities.

User interfaces may be implemented as responsive web applications or native mobile applications, providing access across various devices. Interface design emphasizes usability and accessibility, with intuitive workflows guiding users through policy purchase, claim submission, and status tracking.

Security measures are implemented throughout the system to protect sensitive data and prevent unauthorized access. These measures may include encryption of data in transit and at rest, multi-factor authentication for administrative access, role-based access controls, and regular security audits.

The machine learning components of the system may utilize supervised learning techniques trained on historical vehicle valuation and claims data. Model training processes incorporate validation techniques to prevent overfitting, and deployed models are monitored for drift to maintain accuracy over time.

In embodiments incorporating blockchain technology, the implementation may utilize established blockchain platforms with proven security and performance characteristics. Smart contract code undergoes rigorous testing and auditing to prevent vulnerabilities or unintended behaviors.

The system's architecture supports horizontal scaling to accommodate growth in transaction volume, with stateless application components that can be replicated as needed. Load balancing distributes traffic across available resources, while monitoring systems track performance metrics and alert administrators to potential issues.

These computer-implemented aspects work together to create a robust, secure, and scalable platform for delivering Car Appraisal Insurance (CAP) services.

### Example Scenarios

The following example scenarios illustrate how the Car Appraisal Insurance (CAP) system might operate in various situations. These examples are provided for illustrative purposes and do not limit the scope of the disclosure.

### Scenario 1: Hail Damage Claim

A policyholder's vehicle sustains hail damage during a severe storm. The owner files a claim with their regular auto insurance provider, which covers the cost of repairs. The repair facility reports the incident to a vehicle history report service, resulting in a “hail damage repaired” entry in the vehicle's history report.

The policyholder, who has Car Appraisal Insurance (CAP) coverage, submits a claim through the digital interface, uploading the vehicle history report showing the new entry and documentation of the completed repairs. The system verifies the claim conditions, including confirming that a hailstorm occurred in the policyholder's location on the reported date.

The valuation engine determines that the vehicle's pre-incident value was $25,000, but its post-incident value with the hail damage history is $21,500, representing a $3,500 depreciation. After applying the policy's $500 deductible, the system approves a payment of $3,000 to compensate for the lost value.

### Scenario 2: Dealer-Offered Coverage

A customer purchasing a new vehicle at a dealership is offered Car

Appraisal Insurance (CAP) coverage as an F&I product. The dealer explains that the coverage will protect the vehicle's resale value if it sustains damage that appears on its history report.

The customer opts to purchase the coverage, and the dealer enters the vehicle and customer information into the system through an integration with the dealership management system. The policy is issued immediately, with coverage beginning after a 30-day waiting period.

Six months later, a tree branch falls on the vehicle during a windstorm, causing damage to the hood and windshield. After repairs are completed and the incident appears on the vehicle's history report, the customer files a claim through the mobile app. The system processes the claim according to the standard workflow, resulting in compensation for the calculated depreciation.

### Scenario 3: Fraud Detection

A policyholder submits a claim stating that their vehicle sustained hail damage on a specific date, uploading a vehicle history report showing a hail damage entry and repair documentation. During processing, the fraud detection subsystem identifies several risk indicators:
No significant hail events were reported in the policyholder's area on the claimed date
The repair facility listed on the documentation is not registered in the system's verified repair shop database
The claim was submitted just 31 days after policy inception, immediately after the waiting period

Based on these indicators, the system assigns a high fraud risk score to the claim and routes it for manual review. Upon investigation, an adjuster determines that the documentation has been altered, and the claim is denied. The system records this outcome for future reference, enhancing its fraud detection capabilities.

### Scenario 4: Blockchain Audit Trail

A policyholder submits a legitimate claim for depreciation following flood damage documented in their vehicle's history report. As the claim progresses through the system, each step is recorded on the blockchain:
Policy verification (confirming active coverage at the time of the incident)
History report retrieval (recording a hash of the report showing the flood damage entry)
Repair verification (documenting confirmation of completed repairs)
Valuation determination (recording the calculated depreciation amount)
Payment issuance (documenting the compensation transaction)

Later, when the policyholder sells the vehicle, the buyer questions the vehicle's history and value. The policyholder can reference the blockchain record to demonstrate that the flood damage was properly disclosed and that they received compensation for the associated depreciation, providing transparency and confidence in the transaction.

These scenarios illustrate the versatility and robustness of the Car Appraisal Insurance (CAP) system across different use cases and potential challenges.

### System Operation and Maintenance

Embodiments of the present disclosure include provisions for ongoing operation and maintenance of the Car Appraisal Insurance (CAP) system. These operational aspects ensure the system's continued effectiveness, accuracy, and security over time. The system may incorporate monitoring capabilities that track key performance indicators such as claim processing times, valuation accuracy, and fraud detection effectiveness. Dashboards and alerts provide administrators with visibility into system performance and potential issues requiring attention. Regular updates to valuation data and models ensure that depreciation calculations remain aligned with current market conditions. These updates may include refreshing market pricing data, retraining machine learning models with new sales outcomes, and adjusting regional factors based on observed market trends. The fraud detection subsystem may undergo continuous improvement through analysis of confirmed fraud cases and legitimate claims. This analysis refines the risk scoring algorithms and anomaly detection capabilities, enhancing the system's ability to distinguish between valid and fraudulent claims.

System security is maintained through regular vulnerability assessments, penetration testing, and prompt application of security patches. Access controls and authentication mechanisms are periodically reviewed and updated to address evolving security threats. Backup and disaster recovery procedures ensure data integrity and system availability in the event of hardware failures, natural disasters, or other disruptive events. These procedures may include regular data backups, geographically distributed redundancy, and documented recovery processes. The system's API integrations with external partners are monitored for changes in partner interfaces or data formats. When such changes occur, the integration modules are updated to maintain compatibility and uninterrupted data exchange.

### CAP Coverage Summary Clause

The Car Appraisal Insurance (CAP) insurance system may provide coverage for verified, non-collision incidents that may cause permanent stigma on vehicle history reports, even after full repair. Covered events may include hail, flood, falling objects, glass-only damage, and cosmetic repairs. Optional premium coverage may include vandalism and theft recovery, subject to documentation and insurer reporting.

### Eligibility May Require:

A comprehensive insurance claim payout
   Event recorded on a third-party vehicle history report (e.g., CARFAX or AutoCheck)
Repair documentation or police report, where applicable

CAP may be designed to address post-repair resale value loss not compensated by standard auto or GAP insurance.

### CAP Vandalism

In some embodiments, the Car Appraisal Insurance (CAP) system may include vandalism coverage as part of its comprehensive protection against market value depreciation. Vandalism may differ from natural events like hail or flood in that it may involve human-caused damage, but it may share the key characteristic of creating permanent damage records on vehicle history reports that may negatively impact resale value even after complete physical repairs. The vandalism coverage may be implemented in several ways within the CAP system. In some embodiments, vandalism may be included in a premium tier of coverage with potentially stricter verification requirements. The system may require additional documentation for vandalism claims, such as a police report filed at the time of the incident, to mitigate potential fraud risks. When processing vandalism claims, the fraud detection subsystem may apply enhanced scrutiny. The system may cross-verify the reported vandalism against local crime statistics, verify the timing between policy inception and claim submission, and authenticate repair facility documentation with particular attention to consistency with the reported damage type. The valuation engine may calculate vandalism-related depreciation using specialized parameters that may account for the typically lower market impact of vandalism compared to certain natural events. The engine may apply different depreciation factors based on the severity and nature of the vandalism, with factors potentially ranging from minor cosmetic damage to more significant structural impacts.

In some embodiments, the system may implement specific payout caps for vandalism claims, potentially lower than those for natural events, reflecting the different risk profile and market impact of these incidents. These caps may be configurable based on vehicle type, geographic region, and policy tier. The inclusion of vandalism coverage may enhance the comprehensive nature of the CAP system, providing vehicle owners with protection against a broader range of non-collision incidents that may appear on vehicle history reports and negatively impact resale value. By implementing appropriate fraud controls, verification requirements, and valuation adjustments, the system may maintain financial viability while expanding the scope of coverage to include this common form of vehicle damage. The Car Appraisal Insurance (CAP) system may provide several technological and procedural improvements to strengthen its effectiveness, security, and market position. Enhanced Safety & Security Measures include but are not limited to the following.

### Data Privacy Assurance

The system may implement comprehensive data privacy protections that may include regulatory compliance with specific data privacy laws applicable in target markets. Data minimization and anonymization techniques may be employed, particularly for machine learning training data and analytics. The system may provide granular user consent mechanisms for data collection, usage, and sharing with third parties, with clear options for users to access, modify, or delete their data where feasible and legally required.

### Cybersecurity Fortification

The system may incorporate threat modeling to protect against specific cyber threats relevant to financial/insurance platforms, such as DDOS attacks, credential stuffing, and API vulnerabilities. Secure software development lifecycle practices may be integrated into the system's design and maintenance processes. The system may implement procedures for vetting and monitoring the security practices of integrated third-party data providers.

### User Financial Safety & Transparency

The system may enhance transparency around the valuation process by providing users with simplified explanations for key factors influencing their specific depreciation calculation. Clear communication protocols may be implemented to explain policy terms, exclusions, deductibles, claim status updates, and the process for appealing decisions. When offered via dealerships, specific measures may be included to ensure fair sales practices, clear cost/term disclosures, and prevention of pressure selling.

### Operational Resilience & Reliability

The system may define specific Recovery Time Objectives (RTO) and Recovery Point Objectives (RPO) for critical system functions and data. Enhanced monitoring may be implemented to detect system degradation or data feed issues proactively. The system may define fallback procedures or manual review triggers if primary data sources become unavailable or provide conflicting information.

### Ethical & Algorithmic Fairness

The system may address the risk of bias in machine learning models used for valuation and fraud detection, with steps to detect, measure, and mitigate unfair biases based on protected characteristics or irrelevant factors. Methods may be incorporated to provide some level of explanation for AI-driven decisions to users or internal reviewers. The system may explicitly incorporate adaptive algorithms or emerging valuation methods that may emerge later, providing ongoing strategic flexibility. Current insurance systems do not directly address resale value depreciation caused by vehicle history reports stemming from non-total-loss “Act of God” events. This gap represents a distinct and unmet market need that existing insurance policies fail to cover.

### Technical Detail & System Architecture

The system may feature extensive coverage of various modules, including a valuation engine, fraud detection subsystem, API integrations, and an audit trail. Incorporating detailed diagrams and modular descriptions can help clarify the implementation and may support compliance with the USPTO's enablement and written description requirements. Furthermore, the inclusion of technologies such as blockchain, machine learning-powered valuation, and API-based data verification may enhance the system's defensibility and strengthen its overall patent position. The system includes an integrated fraud prevention subsystem that utilizes a combination of data sources, including weather records, repair shop documentation, telematics, and document verification processes. This subsystem operates within the broader valuation and verification platform to identify inconsistencies and potential fraud events associated with vehicle history.

In one embodiment, the system further incorporates a blockchain-based architecture to record, verify, and timestamp critical data events. The blockchain ledger may be configured to operate in parallel with traditional system modules, providing an immutable audit trail and enhancing data security and transparency. This approach allows for the decentralized validation of records without limiting the ability to enforce ownership or platform-specific claims. The platform architecture enables seamless interoperability among various stakeholders, including insurers, consumers, repair shops, and valuation engines. This is achieved through modular system components and defined API communication protocols. Each module, such as the valuation engine, fraud detection subsystem, and data integration interface, functions independently yet communicates with others through standardized message formats.

The system design includes smart contract functionality deployed via blockchain protocols. These smart contracts may encode transaction conditions, verification steps, and consensus mechanisms for secure operation. Cryptographic verification and ledger consensus may be used to validate user-submitted documents and third-party data feeds. Flowcharts and system diagrams accompanying the implementation detail the interaction between machine learning models, data pipelines, and smart contract triggers. This modular and extensible design supports adaptability across various regulatory environments while maintaining the integrity and enforceability of the system's core functionality.

### Explicit Smart Contract Claims

Clearly articulate and claim specific blockchain smart contract conditions, consensus mechanisms, and cryptographic verification processes employed, emphasizing unique security features.

### Explicit Operational Examples for Enhanced Infringement Protection

### Example 1: Regional Adaptive Valuation

A vehicle may experience hail damage in Austin, Texas. The valuation engine may automatically integrate real-time local market data via API, compare against historical sale trends of similar vehicles in Texas with hail damage, and calculate a regionally specific depreciation. Blockchain smart contracts may verify the transaction details and trigger automatic payout post-verification.

### Example 2: Blockchain Smart Contract Claims Processing

A policyholder may submit a claim for flood damage depreciation. Upon submission, a smart contract may check the verified repair completion record, weather data validation, and third-party vehicle history report. Once confirmed, the smart contract may trigger an automatic payout recorded immutably on the blockchain ledger.

### Example 3: Advanced Fraud Detection Operation

A claim may be submitted just after policy inception. The fraud subsystem may flag the submission based on temporal proximity and initiate cross-verification with weather databases and repair facility records. An anomaly detection algorithm may further assess claim patterns against historical data. The elevated fraud risk score may trigger a manual review, potentially preventing fraudulent payout.

User feedback mechanisms allow policyholders and system administrators to report issues or suggest improvements. This feedback informs the prioritization of system enhancements and usability refinements in subsequent updates.

Documentation of system components, interfaces, and operational procedures is maintained and updated as the system evolves. This documentation supports training of new personnel, troubleshooting of issues, and knowledge transfer across the organization.

Through these operational practices, the Car Appraisal Insurance (CAP) system maintains its effectiveness and adapts to changing market conditions, technological advances, and user needs over time.

In conclusion, the Car Appraisal Insurance (CAP) Insurance system disclosed herein represents a novel and comprehensive solution to address market value depreciation caused by damage events recorded in vehicle history reports. By combining specialized insurance coverage with advanced technological components, the system provides vehicle owners with protection against the financial impact of damage-related stigma that persists even after proper repairs have been completed.

The system's modular architecture, featuring interconnected components such as the central database, valuation engine, fraud detection module, and customer interfaces, ensures flexibility, scalability, and adaptability to various market conditions and regulatory environments. The automated claims processing workflow streamlines the verification, valuation, and payment processes, delivering an efficient experience for both policyholders and insurers.

The depreciation valuation engine, with its sophisticated algorithms and potential machine learning capabilities, provides accurate and data-driven calculations of value loss, while the fraud prevention subsystem maintains the integrity and financial viability of the program through multi-layered verification techniques. Optional features such as the blockchain-based audit trail further enhance transparency and trust in the claims process.

Integration capabilities with external systems enable the Car Appraisal Insurance (CAP) Insurance to be offered through various channels, including traditional insurance providers, automotive dealerships, manufacturers, and financial institutions. This versatility expands the market reach and accessibility of the protection.

The computing infrastructure supporting the system ensures reliable performance, data security, and scalability to accommodate growing demand and evolving technological requirements. The detailed implementation aspects described herein provide a solid foundation for deploying and operating the system in real-world scenarios.

Through this comprehensive approach, the Car Appraisal Insurance (CAP) Insurance system fills a significant gap in the automotive insurance market, addressing a financial risk that has traditionally been uninsured. By protecting vehicle owners against market value depreciation caused by damage history, the system preserves consumer equity and enhances trust in vehicle transactions, ultimately benefiting stakeholders throughout the automotive ecosystem.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. It is to be understood that the foregoing description is not intended to limit the scope of the present disclosure. The present disclosure contemplates numerous variations, modifications, and adaptations that will become apparent to those skilled in the art upon reading and understanding the foregoing description. The scope of the present disclosure is defined by the appended claims and their legal equivalents.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A computer-implemented vehicle-history-based data-integrity verification and valuation system, comprising:
one or more processors and memory storing instructions that, when executed, cause the system to:
(a) retrieve heterogeneous vehicle-history records describing a damage event from a plurality of independent third-party vehicle-history data providers via application-programming interfaces;
(b) process the heterogeneous vehicle-history records into a standardized format defined by standardized message formats and consistency-check rules stored in the memory;
(c) cross-validate the standardized records against at least one additional external data source prior to performing any valuation computation, the cross-validation comprising detecting inconsistencies and conflict indicators among the third-party vehicle-history records;
(d) execute, via independently functioning modules, (i) a fraud prevention subsystem configured to determine whether the records satisfy verification consistency checks, and (ii) a valuation engine module configured to compute a pre-event value and a post-event value using market-valuation data;
(e) generate a valuation output only when the fraud prevention subsystem determines that the verification consistency checks are satisfied, thereby preventing processing of unverified multi-source vehicle-history data; and
(f) record the verification results and valuation output in an audit log to preserve event provenance;
wherein the cross-validation prior to valuation and the independent functioning of the fraud prevention subsystem from the valuation engine module collectively improve the functioning of the computer system by preventing inconsistent multi-source vehicle-history data from being used in valuation operations.

2. The system of claim 1, wherein the heterogeneous vehicle-history records comprise at least two of: accident reports, repair records, title history, odometer readings, or insurance claim records.

3. The system of claim 1, wherein the standardized message formats comprise a normalized data schema that maps disparate field names from different providers to a common vocabulary.

4. The system of claim 1, wherein the consistency-check rules stored in the memory comprise predefined validation criteria including date-range verification, VIN format validation, and damage-severity plausibility checks.

5. The system of claim 1, wherein the cross-validation further comprises comparing damage event descriptions across providers to identify discrepancies in reported damage location, severity, or repair cost.

6. The system of claim 1, wherein the fraud prevention subsystem applies a fraud risk score based on detected inconsistencies, and the valuation output is generated only when the fraud risk score is below a predetermined threshold.

7. The system of claim 1, wherein the valuation engine module computes diminished value as the difference between the pre-event value and the post-event value.

8. The system of claim 7, wherein the diminished value computation further incorporates regional market adjustment factors.

9. The system of claim 1, wherein the audit log comprises an immutable record of each data source consulted, timestamps of retrieval, and hash values of received data for provenance verification.

10. The system of claim 1, wherein the independently functioning modules communicate through a defined message interface without sharing intermediate computational state.

11. The system of claim 1, wherein the fraud prevention subsystem generates a verification certificate upon successful completion of all consistency checks.

12. The system of claim 11, wherein the valuation engine module requires receipt of the verification certificate before executing any valuation computation.

13. The system of claim 1, wherein the plurality of independent third-party vehicle-history data providers comprises at least CARFAX, AutoCheck, and a government motor vehicle agency.

14. The system of claim 1, further comprising a user interface configured to display verification status and valuation results to a user.

15. The system of claim 1, wherein upon detection of inconsistencies that cannot be resolved, the system generates an exception report identifying the conflicting data sources and specific discrepancies.

16. A computer-implemented method for vehicle-history data integrity verification and valuation, comprising the steps performed by one or more processors of: retrieving, processing, cross-validating, executing via independently functioning modules, generating only when verification succeeds, and recording, as recited in claim 1.

17. The method of claim 16, wherein the cross-validating step is completed in its entirety before any valuation computation begins.

18. The method of claim 16, further comprising blocking all valuation output if the fraud prevention subsystem detects unresolved inconsistencies.

19. A non-transitory computer-readable medium storing instructions that, when executed by one or more processors, cause the processors to perform the operations of claim 1.

20. The non-transitory computer-readable medium of claim 19, wherein the instructions further cause the processors to automatically retry retrieval from a third-party provider upon initial connection failure, up to a predetermined maximum number of attempts. [symbol] history entries, wherein the policy is independent of any third-party collision liability coverage;
(b) store, in association with the issued policy, a pre-loss vehicle valuation baseline derived from real-time market data retrieved via one or more application programming interfaces from external vehicle valuation data sources;
(c) periodically update the pre-loss vehicle valuation baseline during the policy term by retrieving current market data via the one or more application programming interfaces;
(d) monitor, via computer-implemented automated polling at predetermined intervals of a third-party vehicle history reporting service, for a new incident record associated with the insured vehicle, the incident record corresponding to a non-total-loss damage event;
(e) upon detection of the new incident record, automatically transition the policy from an active-coverage state to a claim-triggered state without requiring manual claim submission by the vehicle owner, wherein the state transition is initiated solely by the system upon detection of the incident record;
(f) execute, via a machine learning-enabled valuation engine trained on a structured training dataset maintained by the system and comprising historical vehicle transaction records including paired pre-incident and post-incident sale price data for vehicles of the same make, model, year, and mileage range, a diminished value computation that determines a post-incident vehicle value based on: (i) the stored pre-loss vehicle valuation baseline, (ii) the detected incident record, and (iii) contemporaneous external market data retrieved via the one or more application programming interfaces, wherein execution of the diminished value computation is performed upon verified concurrent availability of (i)-(iii); and
(g) automatically initiate, via an electronic payment processing module, execution of a computer-controlled funds transfer of a computed value-loss amount to the vehicle owner based on the diminished value computation; and (h) wherein the transition from the claim-triggered state to a claim-settled state, including execution of the funds transfer, is performed automatically by the system without requiring user input following detection of the incident record.

22. The system of claim 21, wherein the one or more application programming interfaces include connections to at least two independent vehicle valuation data sources, and wherein the machine learning-enabled valuation engine aggregates data from the at least two independent sources to produce the computed value-loss amount.

23. The system of claim 21, wherein the machine learning-enabled valuation engine applies vehicle-specific adjustment factors including at least vehicle type, model year, mileage, and geographic region of registration.

24. The system of claim 21, wherein the machine learning-enabled valuation engine applies incident-specific adjustment factors including at least damage severity classification and repair cost relative to vehicle value.

25. The system of claim 21, wherein the predetermined intervals for automated polling are configurable based on policy parameters.

26. The system of claim 21, wherein the system further comprises a policyholder interface configured to display, in real time, the current pre-loss valuation baseline and policy status.

27. The system of claim 21, wherein the transition from the active-coverage state to the claim-triggered state further requires system-detected confirmation of repair completion, wherein such confirmation is derived solely from data retrieved via automated polling of one or more third-party vehicle service or repair record data sources, without manual input from the vehicle owner.

28. The system of claim 21, wherein the diminished value insurance policy is offered as a standalone financial product separate from comprehensive or collision vehicle insurance coverage.

29. A computer-implemented method for automated first-party vehicle diminished value insurance, comprising:
issuing, by a computing system, a diminished value insurance policy to a vehicle owner, the policy being bound and in force for a defined coverage term prior to any loss event and prior to any incident history entry existing for the insured vehicle, the policy establishing a contractual first-party payment obligation for value depreciation caused by incident history entries, wherein the policy is independent of any third-party collision liability coverage;
storing, by the computing system in association with the issued policy, a pre-loss vehicle valuation baseline derived from real-time market data retrieved via one or more application programming interfaces;
monitoring, by the computing system via computer-implemented automated polling at predetermined intervals of a third-party vehicle history reporting service, for a new incident record associated with the insured vehicle;
upon detection of the new incident record, automatically transitioning the policy from an active-coverage state to a claim-triggered state without requiring manual claim submission, wherein the state transition is initiated solely by the system upon detection of the incident record;
executing, by a machine learning-enabled valuation engine trained on a structured training dataset maintained by the system and comprising historical vehicle transaction records including paired pre-incident and post-incident sale price data for vehicles of the same make, model, year, and mileage range, a diminished value computation that produces a computed value-loss amount; and
automatically initiating, without human approval or intervention, via an electronic payment processing module, execution of a computer-controlled funds transfer of the computed value-loss amount to the vehicle owner within a system-controlled processing window defined by policy parameters.

30. The method of claim 29, further comprising periodically updating the pre-loss vehicle valuation baseline during the policy term by retrieving current market data via the one or more application programming interfaces.

31. The method of claim 29, wherein the machine learning-enabled valuation engine is periodically retrained using updated historical vehicle transaction data to improve accuracy of the diminished value computation.

32. A non-transitory computer-readable medium storing instructions that, when executed by one or more processors of a computing system, cause the computing system to perform the method of claim 29.

33. The system of claim 21, wherein the one or more processors are further configured to execute the following sequence in order: (i) establish the pre-loss valuation baseline prior to any incident record existing for the insured vehicle; (ii) monitor for an incident record via automated polling of a third-party vehicle history reporting service at predetermined intervals; (iii) upon detection of an incident record, automatically execute the machine learning-enabled valuation computation without manual initiation; and (iv) automatically initiate funds transfer within the system-controlled processing window without human approval, wherein no step in the sequence requires or awaits manual input from the vehicle owner or any other person.
